(19) United States
(12) Patent Application Publication
(10) Pub. No.: US 2019/0269119 A1
(43) Pub. Date: Sep. 5, 2019

(54) Wearable Fishing Rod Holder

(71) Applicant: Christopher Vandamia, Eighty Four, PA (US)

(72) Inventor: Christopher Vandamia, Eighty Four, PA (US)

(21) Appl. No.: 16/418,519

(22) Filed: May 21, 2019

Related U.S. Application Data
(60) Provisional application No. 62/789,613, filed on Jan. 8, 2019.

(51) Int. Cl. A01K 97/10

(52) U.S. Cl. CPC A01K 97/10

(57) ABSTRACT

A wearable fishing rod holder. The wearable fishing rod holder includes a base adapted to rest on a thigh of a user. The contours of the base mimic the contours of a user's thigh. At least one lateral strap is removably secured to opposing lateral edges of the base. At least one upper strap is removably secured to a top edge of the base. A receptacle is disposed on an outer surface of the base. The receptacle includes an open upper end and a lower end, defining an interior channel that receives the bottom portion of a fishing rod. In one embodiment, at least one notch disposed on a top edge of the receptacle, configured to receive a cross-brace of a fishing rod.

### CROSS REFERENCE TO RELATED APPLICATIONS

This application claims the benefit of U.S. Provisional Application No. 62/789,613 filed on Jan. 8, 2019. The above identified patent application is herein incorporated by reference in its entirety to provide continuity of disclosure.

### BACKGROUND OF THE INVENTION

The present invention relates to fishing rod holders. More particularly, the present invention provides for a wearable fishing rod holder that a user can utilize to maintain a fishing rod in a comfortable upright position while fishing, thereby freeing the user's hands to accomplish tasks.

Many people enjoy fishing with a rod and reel. However, once the line is cast the individual must wait for a fish to strike the bait and must maintain a close eye on the line. Placing a fishing rod on the ground once the line has been cast can be dangerous. The fishing rod is at constant risk of being damaged if placed on the ground or another surface, as a fish can strike at any time and drag the fishing rod away, sometimes at great speed or into the water. An individual must maintain control over the fishing rod, which typically means that the individual must always keep at least one hand on the pole. Fixing the fishing line, freeing a snag, and other maintenance activities, while the line is out, can be quite difficult to accomplish one-handed. Therefore, hands-free operation of the fishing rod is desired, and there is a need for a solution which keeps the fishing rod close at hand while also not requiring the fishing rod to be constantly held in an individual's hands.

Devices have been disclosed in the known art that relate to fishing rod holders. These include devices that have been patented and disclosed in patent application publications. However, the devices in the known art have several drawbacks. Some fishing rod holders must be worn across the body which can severely restrict an individual's ability to move about freely and manipulate the fishing line. Other fishing rod holders are designed to be used in a sitting position, and do not provide the ability for a user to move around, as may be necessary. Still other fishing rod holders have unneeded compartments and pouches which adds weight and complicates the device.

The present invention substantially diverges in design elements from the known art and consequently it is clear that there is a need in the art for an improvement to existing fishing rod holders. In this regard the present invention substantially fulfills these needs.

### SUMMARY OF THE INVENTION

In view of the foregoing disadvantages inherent in the known types of fishing rod holders now present in the prior art, the present invention provides a wearable fishing rod holder wherein the same can be utilized by an individual for maintaining control of a fishing rod, hands-free. The present wearable fishing rod holder comprises a base adapted to rest on a thigh of a user. The contours of the base mimic the contours of a user's thigh. At least one lateral strap is removably secured to opposing lateral edges of the base. At least one upper strap is removably secured to a top edge of the base. A receptacle is disposed on an outer surface of the base. The receptacle includes an open upper end and a lower end, defining an interior channel that receives the bottom portion of a fishing rod. In one embodiment, at least one notch disposed on a top edge of the receptacle, configured to receive a cross-brace of a fishing rod.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front view of an embodiment of the wearable fishing rod holder.

FIG. 2 shows a perspective view of an embodiment of the wearable fishing rod holder, with a focus on the base.

FIG. 3 shows a perspective view of an embodiment of the wearable fishing rod holder, in use.

### DETAILED DESCRIPTION OF THE INVENTION

Reference is made herein to the attached drawings. Like reference numerals are used throughout the drawings to depict like or similar elements of the wearable fishing rod holder. For the purposes of presenting a brief and clear description of the present invention, a preferred embodiment will be discussed as used for the wearable fishing rod holder. The figures are intended for representative purposes only and should not be considered to be limiting in any respect.

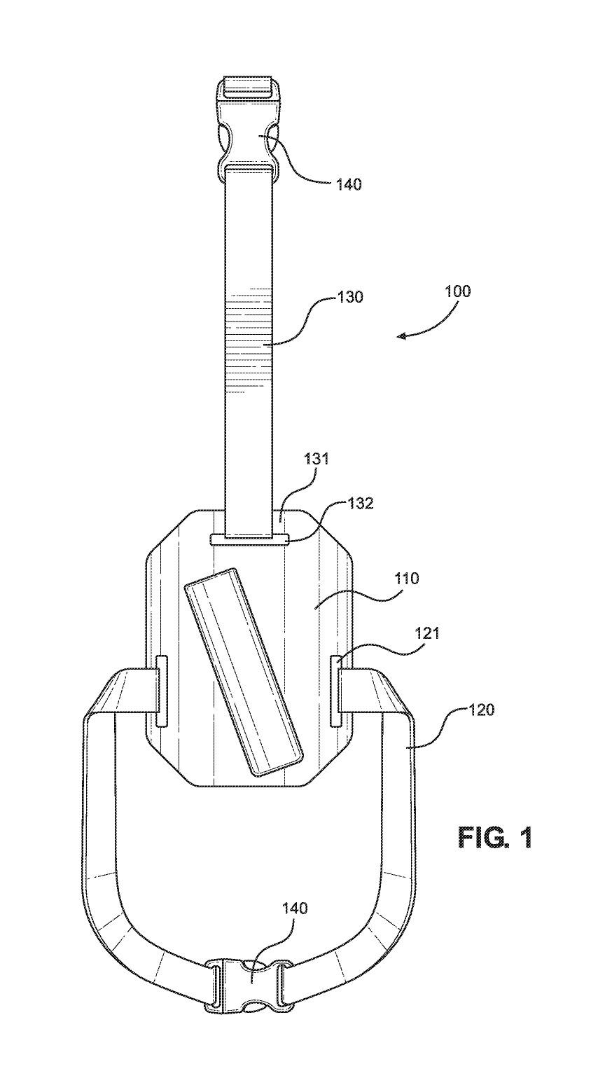

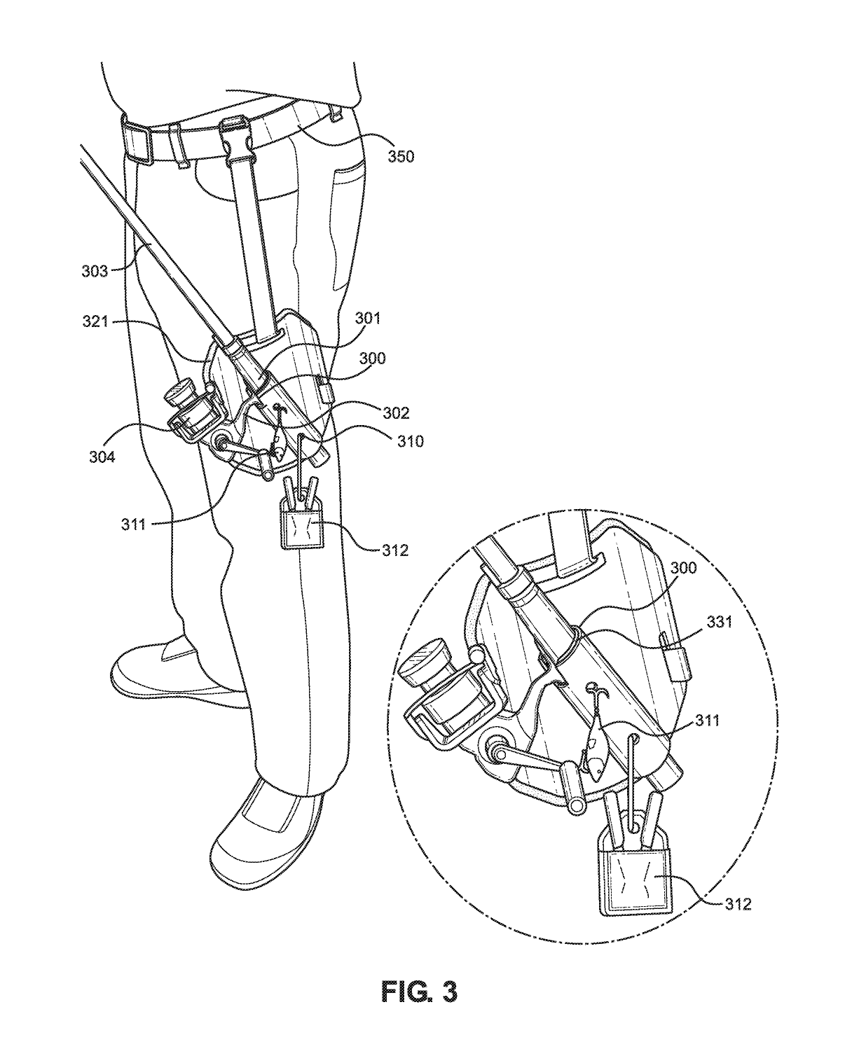

Referring now to FIG. 1, there is shown a front view of an embodiment of the wearable fishing rod holder. The wearable fishing rod holder 100 comprises a base 110 adapted to rest on a thigh of a user. The base 110 is contoured such that an inner surface (as shown in FIG. 3, 320) of the base 110 mimics the contours of a user's thigh. In the shown embodiment, the base 110 is concave so that the base 110 covers not only a front portion of a user's thigh, but also wraps around to the sides of the user's thigh. In such an embodiment, the greater surface area of the base 110 in contact with the user's thigh provides for greater stability and a custom fit for the user.

At least one lateral strap 120 is removably securable to opposing lateral edges of the base 110. In the shown embodiment, the base 110 includes two lateral slots 121, each disposed near an opposing distil edge of the base 110. In such an embodiment, a single lateral strap 120 is threaded through the two lateral slots 121, behind the base 110. At least one upper strap 130 is also removably securable to a top portion 131 of the base 110 via a fastener disposed on opposing ends of the upper strap 130. In the shown embodiment, the base 110 includes a top slot 132 disposed near the top edge 131 of the base 110. In such an embodiment, a single upper strap 130 is threaded through the top slot 132. The single upper strap 130 is threaded around, and in such a way secured to, a belt (as shown in FIG. 3, 350) of the individual.

In one embodiment, the at least one lateral strap 120 and the at least one upper strap 130 are all selectively adjustable. In the shown embodiment, an adjusting buckle 140 is disposed on a distil end of each strap 120, 130. The adjusting buckle 140 is configured to receive a length of the strap 120, 130 therethrough, and to hold a position of the strap 120, 130 when secured. In this manner, an individual selectively determines the length of each strap 120, 130 when disposed around the thigh of the individual and secured about the individual's belt. Through utilization of the adjusting buckle 140, the individual customizes the fit of the wearable fishing rod holder on their thigh and the positioning thereof. The lateral strap 120 allows the individual to determine how snugly the wearable fishing rod holder is secured to their thigh, and the upper strap 130 allows the individual to determine how the height of the base 110 relative to the individual's thigh.

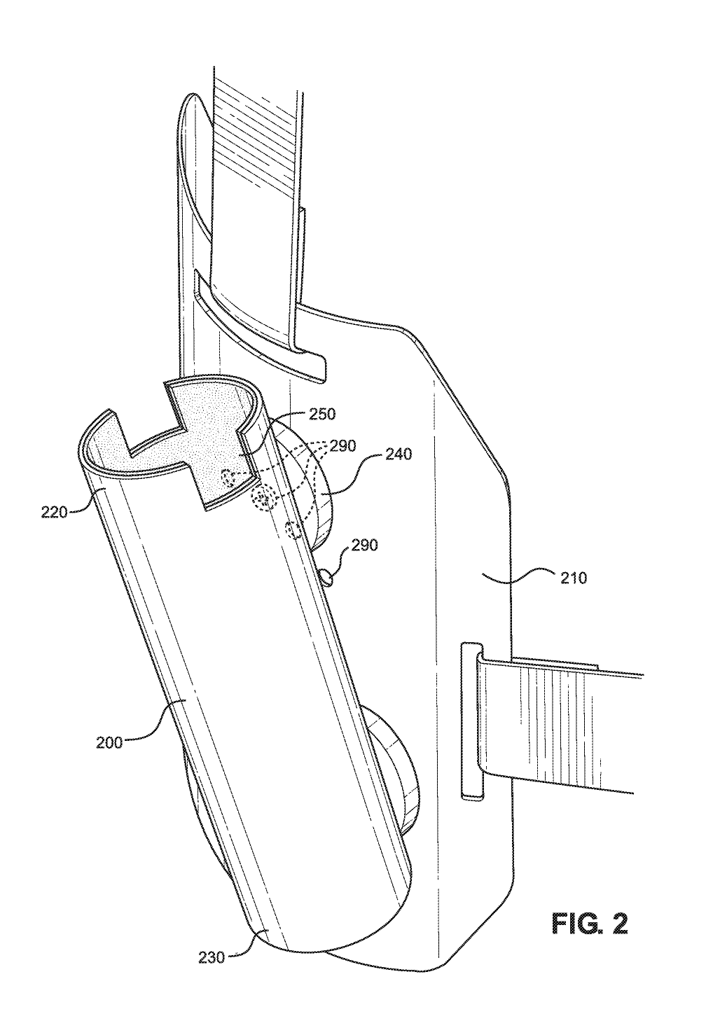

Referring now to FIG. 2, there is shown a perspective view of an embodiment of the wearable fishing rod holder, with a focus on the base. A receptacle 200 is disposed on an outer surface 210 of the base 110. The receptacle 200 includes an open upper end 220 and a lower end 230, defining an interior volume 250. In the shown embodiment, a plurality of spacers 240 are disposed between the outer surface 210 of the receptacle 200 and the base 110 on a top portion of the receptacle 200. In one embodiment, the spacers 240 are disposed only on a top portion of the receptacle 200 which provides an angle at which the top of the receptacle 200 is disposed relative to the user's thigh. In such a manner, when a fishing rod (as shown in FIG. 3, 301) is received by the receptacle 200, the angle of the receptacle 200 is transferred to the fishing rod, thereby angling the fishing rod away from the user. Such an angle provides greater ease for the user to work with the line and components of the fishing rod when the rod is in use. In another embodiment, the spacers 240 are disposed along the length of the receptacle 200 resulting in no angle of the receptacle. In such an embodiment, the lack of an angle being transferred to the fishing rod may be preferential to a user when interacting with the end of the fishing rod opposite of the handle. The spacers 240 in either embodiment provide a buffer zone between the receptacle 200 and the base 110, such that the receptacle 200 does not rub and wear the base 110, or vice versa.

The interior volume 250 of the receptacle 200 is configured to removably receive a bottom portion of a fishing rod. In the shown embodiment, the receptacle 200 is cylindrical in order to fully surround, protect and support the shape of the fishing rod. In the shown embodiment, the lower end of the receptacle 200 is open, and the receptacle 200 is a hollow tube. In such an embodiment, the bottom portion of the fishing rod, being that portion of the fishing rod on which a handle is disposed, is free to pass through the lower end of the receptacle 200. In one embodiment, the lower end of the receptacle 200 is closed, and in such an embodiment, the bottom portion of the fishing rod can rest on, and be received by, the lower end of the receptacle 200.

In the shown embodiment, the receptacle 200 is disposed at an angle relative to a length of the base 110. In such an embodiment, the angle is set such that where a fishing rod is received by the receptacle 200, the fishing rod is angled away from the front of the individual. In such a manner, the fishing rod, when in use and received by the receptacle 200, will be pointing at an upright angle towards the water. Such an angle is preferred while fishing as it allows the fishing line to freely run along the length of the fishing rod when an individual is reeling in the lure. Such an angle also keeps the fishing rod upright and secured in the receptacle 200 and reduces the chances that the fishing rod will accidentally fall out of the receptacle 200.

In one embodiment, the angle of the receptacle 200 relative to the length of the base 110 is selectively adjustable. In one embodiment, a bottom portion of the receptacle 200 is pivotally attached to the base 110 and a top portion of the receptacle 200 is removably secured to one of a plurality of attachment apertures 290. In the shown embodiment, a user can select from one of a plurality of attachment apertures 290 through which the top portion of the receptacle 200 is secured. In various embodiments, the plurality of attachment apertures 290 are disposed in a variety of locations, such that securing the top portion of the receptacle 200 to a selected attachment aperture results in a given angle at which the fishing rod is held. In such an embodiment, the selection of a different one of the plurality of attachment apertures 290 results in a different angle. In other embodiments, the top portion of the receptacle 200 is pivotally attached to the base 110 and a bottom portion of the receptacle 200 is removably secured to one of a plurality of attachment apertures 290. In other embodiments both the top and bottom portions of the receptacle 200 are removably secured to the plurality of attachment apertures 290. Such a variety of angles allows the user to adjust for the height and personal preferences of the user while fishing. Further, the selectively adjustable angle allows the user to secure the base 110 to either their right leg or left leg, and then selectively adjust the angle of the receptacle 200 such that the fishing rod is angled at a preferred angle.

Referring now to FIG. 3, there is shown a perspective view of an embodiment of the wearable fishing rod holder, in use. In various embodiments, at least one notch 300 is disposed on a top edge 310 of the receptacle 200. The notch 300 is configured to receive various parts of a fishing rod 301 to further secure the fishing rod 301 in the receptacle. In the shown embodiment, the notches 300 are configured to receive a cross-brace 302 of a fishing rod 301, wherein the cross-brace 302 of the fishing rod 301 is a member of the fishing rod 301 that connects the fishing pole 303 to the fishing reel 304. In the shown embodiment, the cross-brace 302 rests inside of a singular notch 300, thereby further securing the fishing rod 301 in the receptacle 200. Further, in the shown embodiment, two notches 300 are disposed on opposing top edges 310 of the receptacle 200 in order to allow for the fishing rod 301 to be secured with the fishing reel 304 facing away from the user's body regardless of which leg of the user the wearable fishing rod holder is secured to.

In various embodiments, the receptacle 200 further comprises a plurality of receiving apertures 310. In the shown embodiment, two receiving apertures 310 are disposed through the receptacle 200. The receiving apertures 310 are configured to receive various paraphernalia 311, such as spare fishing lures, hooks, and associated materials. In this manner, a user will have ready access to such paraphernalia 311 to use while fishing. For example, where a fishing line breaks and a new lure and hook need to be attached, a user is able to retrieve such back-up lures and hooks from the receiving aperture 310 instead of having to retrieve such paraphernalia 311 from a tackle box or other storage container. Additionally, the receiving apertures 310 provide a location at which a user can further attach other accoutrements. In the shown example, a pouch 312 is secured to the receptacle 200 via the receiving apertures 310 thereby providing a storage location for various tools used while fishing, such as a pair of pliers.

In various embodiments, a cushioning material 321 is disposed on an inner surface of the base 110. The cushioning material 321 provides the user with added comfort and protection from the edges and inner surface of the base 110. In one embodiment, the cushioning material 321 is memory foam. In another embodiment, the cushioning material 321 is microfiber. In various embodiments, an inner surface of the receptacle 200 further comprises a padded material 331. Similar to the function of the cushioning material 321, the padded material 331 provides protection to the fishing rod 301 from the inner surface of the receptacle 200. Additionally, in embodiments in which a notch 300 is disposed in the receptacle 200, the padded material 331 provides protection to the fishing rod 301 from the surfaces of the notch 300.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A wearable fishing rod holder, comprising:
a base adapted to rest on a thigh of a user;
wherein an inner surface of the base mimics a contour of a user's thigh;
at least one lateral strap removably securable to a plurality of opposing lateral edges of the base;
at least one upper strap removably securable to a top edge of the base;
a receptacle disposed on an outer surface of the base;
the receptacle includes an open upper end and a lower end, defining an interior channel;
the interior channel configured to removably receive a bottom portion of a fishing rod.

2) The wearable fishing rod holder of claim 1, wherein the receptacle is cylindrical.

3) The wearable fishing rod holder of claim 2, wherein the receptacle further comprises a plurality of receiving apertures.

4) The wearable fishing rod holder of claim 1, wherein a cushioning material is disposed on an inner surface of the base.

5) The wearable fishing rod holder of claim 4, wherein the cushioning material is memory foam.

6) The wearable fishing rod holder of claim 4, wherein the cushioning material is microfiber.

7) The wearable fishing rod holder of claim 1, wherein a length of the lateral and upper straps is selectively adjustable.

8) The wearable fishing rod holder of claim 1, wherein the lower end of the receptacle is open.

9) The wearable fishing rod holder of claim 1, wherein a bottom portion of the receptacle is pivotally attached to the base and a top portion of the receptacle is removably secured to one of a plurality of attachment apertures.

10) The wearable fishing rod holder of claim 1, wherein an inner surface of the receptacle further comprises a padded material.

11) A wearable fishing rod holder, comprising:
a base adapted to rest on a thigh of a user;
wherein an inner surface of the base mimics a contour of a user's thigh;
at least one lateral strap removably securable to opposing lateral edges of the base;
at least one upper strap removably securable to a top edge of the base;
a receptacle disposed on an outer surface of the base;
the receptacle includes an open upper end and a lower end, defining an interior channel;
the interior channel configured to removably receive a bottom portion of a fishing rod;
at least one notch disposed on a top edge of the receptacle, configured to receive a cross-brace of a fishing rod.

12) The wearable fishing rod holder of claim 11, wherein the receptacle is cylindrical.

13) The wearable fishing rod holder of claim 12, wherein the receptacle further comprises a plurality of receiving apertures.

14) The wearable fishing rod holder of claim 11, wherein a cushioning material is disposed on an inner surface of the base.

15) The wearable fishing rod holder of claim 14, wherein the cushioning material is memory foam.

16) The wearable fishing rod holder of claim 14, wherein the cushioning material is microfiber.

17) The wearable fishing rod holder of claim 11, wherein a length of the lateral and upper straps is selectively adjustable.

18) The wearable fishing rod holder of claim 11, wherein the lower end of the receptacle is open.

19) The wearable fishing rod holder of claim 11, wherein a bottom portion of the receptacle is pivotally attached to the base and a top portion of the receptacle is removably secured to one of a plurality of attachment apertures.

20) The wearable fishing rod holder of claim 11, wherein an inner surface of the receptacle further comprises a padded material.
